(19) United States
(12) Patent Application Publication
(10) Pub. No.: US 2007/0065255 A1
(43) Pub. Date: Mar. 22, 2007

(54) Thread section for screws

(75) Inventor: Yin-Feng Liu, Taipei (TW)

Correspondence Address: BRUCE H. TROXELL, SUITE 1404, 5205 LEESBURG PIKE, FALLS CHURCH, VA, 22041, US

(73) Assignee: A-Stainless International Co., Ltd.

(21) Appl. No.: 11/230,584

(22) Filed: Sep. 21, 2005

(51) Int. Cl. F16B 35/04

(52) U.S. Cl. 411/411

(57) ABSTRACT

An improved thread section for screws to reduce the torsional force of fastening and provide a tighter coupling to prevent loosening off mainly includes a head and a shank with a thread section. The thread section has a front portion forming inverse front latch threads and a rear portion forming inverse rear latch threads. The front latch threads have a upper portion with four teeth formed on four sides of each thread. Two neighboring teeth form an interval which has a debris collection trough. The front latch threads and rear latch threads can trap a portion of debris in the screw bore. The four teeth can enhance cutting effect during fastening. The debris collection troughs can hold more debris to reduce the resistance during fastening. The gathered debris can increase the coupling tightness between the screw and the screw bore. Thus the invention enables the screw to be fastened more firmly without loosening off and also reduces the torsional force during fastening.

### BACKGROUND OF THE INVENTION

1. Field of the Invention

The invention relates to an improved thread section for screws and particularly to a screw that has an improved thread section to allow fastening with a lower torsional force and provide a firmer coupling and prevent loosening off. The thread section is formed on a shank of the screw, and includes a front portion which has inverse front latch threads and a rear portion which has inverse rear latch threads. The front latch threads have a upper portion which four teeth on four sides of each thread. Two neighboring teeth form an interval which has a debris collection trough.

2. Description of the Prior Art

A conventional screw mainly has a head and a shank below the head with a thread section formed thereon. R.O.C. patent No. 168986 discloses a screw which has cutting teeth on the threads to do cutting and reduce crevices of the screw bore. The cutting teeth are formed like a saw. The width of the threads is constant. If the thread section is formed as the cutting teeth, the width of the thread decreases. As a result, cutting power diminishes. R.O.C. patent No. 212063 discloses another type of screw which has a groove on the shank to facilitate cutting. It performs cutting through the groove. The result is not desirable. As the shank has a limited size, the depth of the groove also is limited. The groove is easily filled by debris. As a result, fastening resistance of the screw increases. It also does not provide a latch function, thus is easily loosening off.

### SUMMARY OF THE INVENTION

In view of the aforesaid disadvantages, the present invention aims to provide an improvement for screws that can be fastened more firmly without loosening off and can be fastened with a lower torsional force.

The invention provides an improved thread section for a screw which has a head and a shank containing a thread section. The thread section has a front portion and a rear portion. The front portion has inverse front latch threads and the rear portion has inverse rear latch threads. The front latch threads further have a upper portion with four teeth formed on four sides of each thread. Two neighboring teeth have an interval which forms a debris collection trough. Thus a portion of debris is trapped in the screw bore and gathered in the debris collection trough. As a result, the screw can be fastened more firmly without loosening off. The teeth also can enhance the cutting effect during fastening. The debris collection trough can contain more debris to reduce the resistance during fastening.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a fragmentary perspective view of the invention.

FIG. 3 is a plain view of the invention.

FIG. 4 is a cross section taken on line A-A in FIG. 3.

### DESCRIPTION OF THE PREFERRED EMBODIMENT

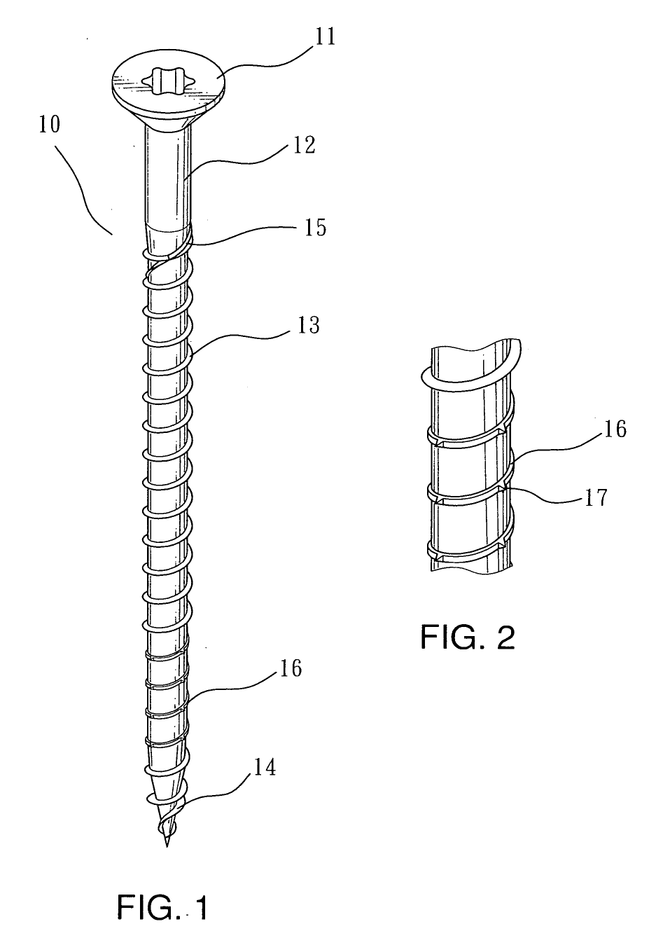

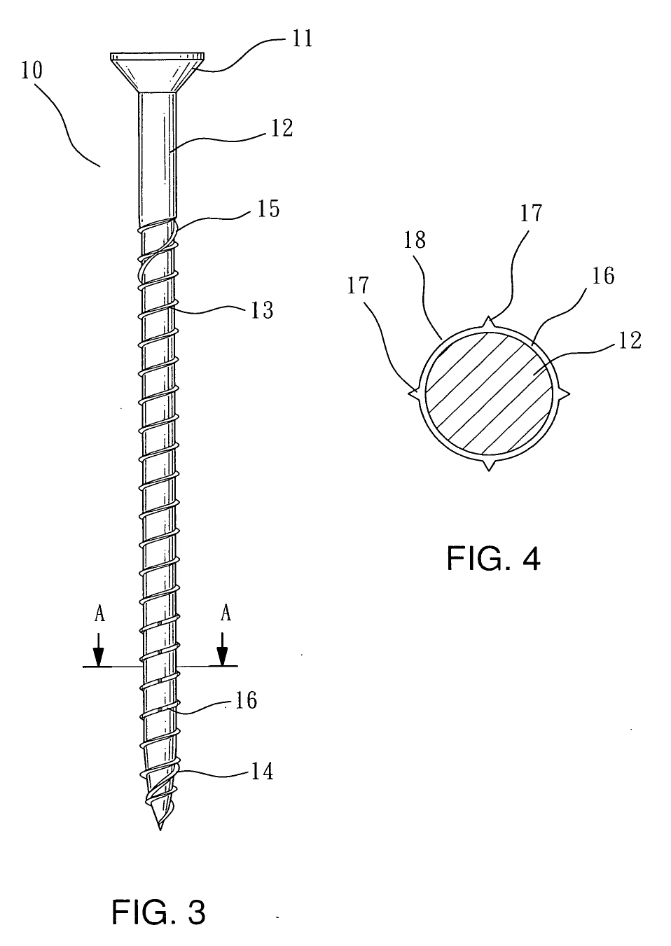

Referring to FIGS. 1 through 4, the screw 10 according to the invention mainly includes a head 11 and a shank 12 which has a pointed end. The shank 12 has a thread section 13.

The thread section 13 has a front portion which forms inverse front latch threads 14 and a rear portion which forms inverse rear latch threads 15. The front and rear latch threads 14 and 15 have a pitch about twice of the pitch of the thread section 13. The front latch threads 14 have a upper portion which has four teeth 16 on four sides of each thread. Two neighboring teeth 16 have an interval 17 to form a debris collection trough 18.

By means of such a structure, when the screw 10 is fastened, the thread section 13 is sunk into an object to be coupled. A portion of debris generated during fastening is trapped by the front latch threads 14 and remains in the screw bore to form a tight coupling with the screw. Therefore the screw and the object can be coupled more firmly. The thread with four teeth 16 can increase cutting power to reduce the torsional force required during fastening. The debris collection trough 18 can contain more debris to form a denser filling and result in a tighter coupling between the screw and the screw bore. As a result, the screw can be fastened more firmly. The rear latch threads 15 on the rear portion also enable the debris and the screw to be coupled more tightly to increase the coupling strength of the screw with the coupling object.

The improved thread section of the invention can provide the following advantages:

1. The screw section of the shank has the front latch threads on the front portion and the rear latch threads on the rear portion, therefore the front and rear portions can be coupled more firmly with the screw bore during fastening of the screw. It overcomes the shortcoming of the conventional screw which often forms a loosened rear portion after fastening.

2. The invention provides threads with four teeth to form debris collection troughs of a greater debris holding capacity. Such a design can improve cutting effect during fastening. The debris collection troughs also can contain more debris to reduce fastening resistance. Thus fastening operation is smoother.

3. As previously discussed, the debris collection troughs have a greater debris holding area to hold more debris in a denser manner. Hence coupling of the screw and the screw bore is tighter. And the screw can be fastened more firmly.

I claim:

1. An improved thread section for a screw which has a head and a pointed shank, the shank having a screw section which has a front portion and a rear portion, the front portion having inverse front latch threads, the rear portion having inverse rear latch threads, the front latch threads having a upper portion which has fourth teeth on four sides of each thread located thereon, two neighboring teeth forming an interval which has a debris collection trough.

2. The improved thread section for a screw of claim 1, wherein the front latch threads and the rear latch threads have a pitch which is twice of the pitch of the thread section.
